(19) United States
(12) Patent Application Publication
(10) Pub. No.: US 2017/0024621 A1
(43) Pub. Date: Jan. 26, 2017

(54) COMMUNICATION SYSTEM FOR GATHERING AND VERIFYING INFORMATION

(71) Applicant: Dura Operating, LLC, Auburn Hills, MI (US)

(72) Inventors: Aaron Evans Thompson, Grand Blanc, MI (US); Donald Raymond Gignac, Waterford, MI (US); Danish Uzair Siddiqui, Rochester Hills, MI (US); Rajashekhar Patil, Ypsilanti, MI (US); Gordon M. Thomas, Beverly Hills, MI (US)

(21) Appl. No.: 15/211,310

(22) Filed: Jul. 15, 2016

Related U.S. Application Data
(60) Provisional application No. 62/194,364, filed on Jul. 20, 2015.

(51) Int. Cl. G06K 9/00; G06K 9/62; H04W 4/04

(52) U.S. Cl. CPC G06K 9/00818; H04W 4/046; G06K 9/6293; G06K 9/00805; G06K 9/00798

(57) ABSTRACT

A system for detecting and classifying information for a motor vehicle is provided. The system includes a sensor mounted within the motor vehicle and a controller in communication with the sensor and having a memory for storing control logic and a processor configured to execute the control logic. The control logic captures optical information from the sensor, classifies the optical information, compares the classified optical information with communication data received by the motor vehicle, generates fused information based on the comparison, and transmits the fused information from the motor vehicle as a source of additional communication data.

### RELATED APPLICATION

This application claims the benefit of U.S. Provisional Patent Application No. 62/194,364, filed on Jul. 20, 2015, the entire contents of which are incorporated herein by reference.

### FIELD

The present disclosure relates to a communication system of motor vehicles. More specifically, the present disclosure relates to a communication system for gathering and verifying information for motor vehicles.

### BACKGROUND

The statements in this section merely provide background information related to the present disclosure and may not constitute prior art.

Recent development of motor vehicles enables them to communicate between the vehicles as well as between the vehicles and other communication systems to inform the vehicles of the operation of the vehicle and the traffic surrounding the vehicle. For example, V2V communication systems share information between system vehicles to provide the host vehicle with information for making driving decisions such as lane changes, braking, route changes and the like. V2V information may also be employed by automatic driver assistance systems to determine an automatic driving action. As such, the information passed between vehicles is used to help determine an automatic driving action, such as recommended lane change, avoidance of hazards, traffic compliance and the like. Accordingly, it should be appreciated that classifying information is helpful in determining an automatic driving action.

### SUMMARY

A system for detecting and classifying information for a motor vehicle is provided. The system includes a sensor mounted within the motor vehicle and a controller in communication with the sensor and having a memory for storing control logic and a processor configured to execute the control logic. The control logic captures optical information from the sensor, classifies the optical information, compares the classified optical information with communication data received by the motor vehicle, generates fused information based on the comparison, and transmits the fused information from the motor vehicle as a source of additional communication data.

In one aspect, the sensor is a forward-view camera.

In another aspect, the optical information includes road signage.

In another aspect, the optical information includes road surface conditions.

In another aspect, the controller includes a detection and classification module that captures the optical information from the sensor and classifies the optical information.

In another aspect, the detection and classification module stores the optical information in a track list.

In another aspect, the detection and classification module includes a range estimation module that determines if the track list information is relevant to the motor vehicle.

In another aspect, the controller includes a telematics communication module that receives communication data and transmits the additional communication data.

In another aspect, the controller includes a target fusion module that receives the classified optical information and the communication data and generates the fused information.

In another aspect, the target fusion module generates the fused information when the classified optical information and the communication data are coincident.

A method for detecting and classifying information for a motor vehicle is also provided. The method includes capturing optical information with a sensor, classifying the optical information, comparing the classified information with communication data received by the motor vehicle, generating fused information based on the comparison of the classified information and the communication data, and transmitting the fused information from the motor vehicle as a source of additional communication data.

In one aspect, the sensor is a forward-view camera mounted within the motor vehicle.

In another aspect, capturing optical information includes capturing information of road signage.

In another aspect, capturing optical information includes capturing information of road surface conditions.

In another aspect, the method includes storing the optical information in a track list.

In another aspect, the method includes estimating if the track list is relevant to the motor vehicle.

In another aspect, a telematics communication module receives communication data and transmits the additional communication data.

In another aspect, a target fusion module receives the classified optical information and the communication data and generates the fused information.

In another aspect, the target fusion module generates the fused information when the classified optical information and the communication data are coincident.

Another system for detecting and classifying information for a motor vehicle. The system includes a detection and classification module that captures optical information from a forward-view camera and classifies the optical information as classified data, a telematics communication module that receives communication data, and a fusion module that combines the classified data and the communication data into fused information. The telematics communication module transmits the fused information from the motor vehicle as a source of additional communication data.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. In the drawings:

FIG. 1 is a top view of an exemplary motor vehicle having a communication system in accordance with the principles of the present disclosure;

FIG. 2 is an illustration showing examples of different road signage recognized by the system;

FIG. 3 is a block diagram showing a traffic sign recognition algorithm for the system;

FIG. 4 is an illustration showing examples of crossing signage recognized by the system;

FIG. 5 is a block diagram showing the operation of a railroad and crosswalk detection program for the system;

FIG. 6 is an illustration showing examples of road surface conditions;

FIG. 7 is an illustration showing an example of a pothole detection algorithm;

FIG. 8 is an illustration showing output from the pothole detection algorithm;

FIG. 9 is a block diagram showing the operation of a pothole and road surface condition detection program for the system; and

FIG. 10 is a flow diagram of a process for using the system.

### DETAILED DESCRIPTION

The following description is merely exemplary in nature and is not intended to limit the present disclosure, application, or uses.

Referring now to the drawings, a communication system for motor vehicles embodying the principles of the present invention is illustrated therein and designated at 18. The system 18 in various arrangements is incorporated into vehicle-to-everything (V2X) communication systems, including but not limited to communication systems such as, for example, vehicle-to-infrastructure (V2I), vehicle-to-vehicle (V2V), vehicle-to-pedestrian (V2P), vehicle-to-device (V2D) and vehicle-to-grid (V2G). The system 18 utilizes sensors to detect optical information that is unknown or newly installed, which is then shared with other system vehicles. Thus, the system vehicles are able to update map information to make better automatic driving decisions.

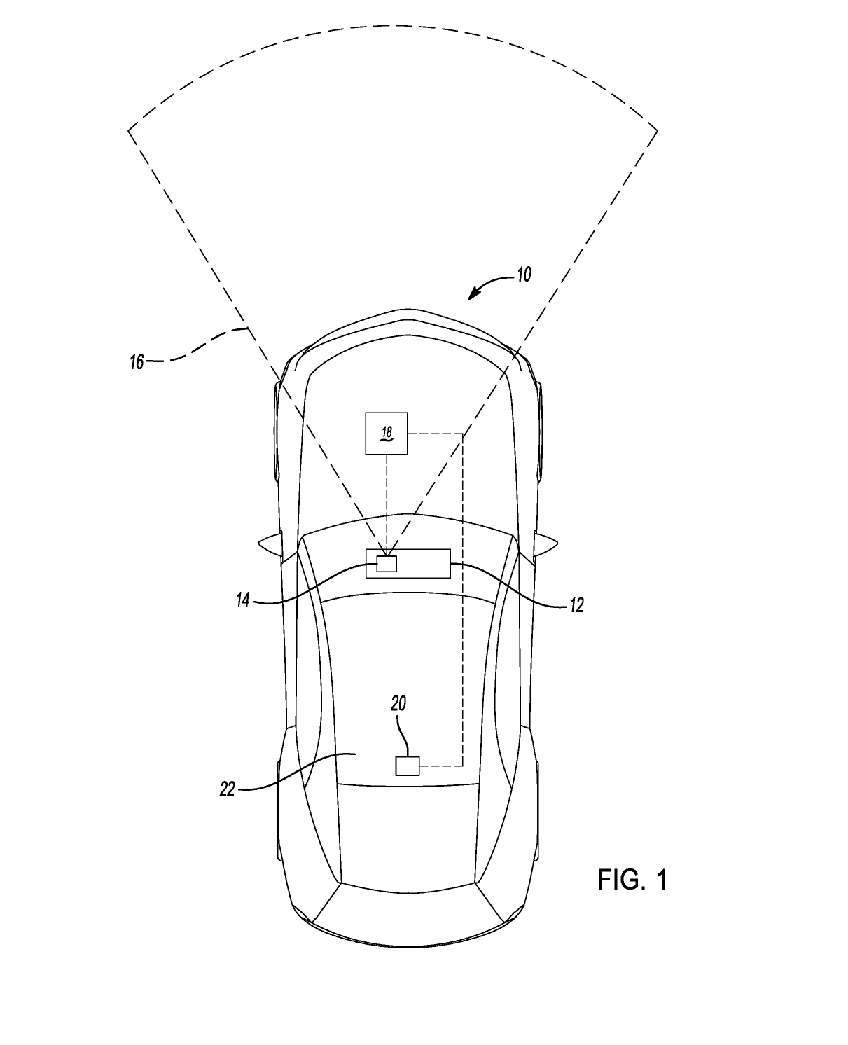

With reference now to FIG. 1, the system 18 is incorporated in a vehicle 10. The system 18 includes a sensor 14 mounted in or adjacent to a rearview mirror 12. The sensor 14 scans optical information in its field of view 16. The system 18 processes the data and transmits data from and receives data to the vehicle 10 through an antenna 20 mounted, for example, on a rooftop 22 of the vehicle 10.

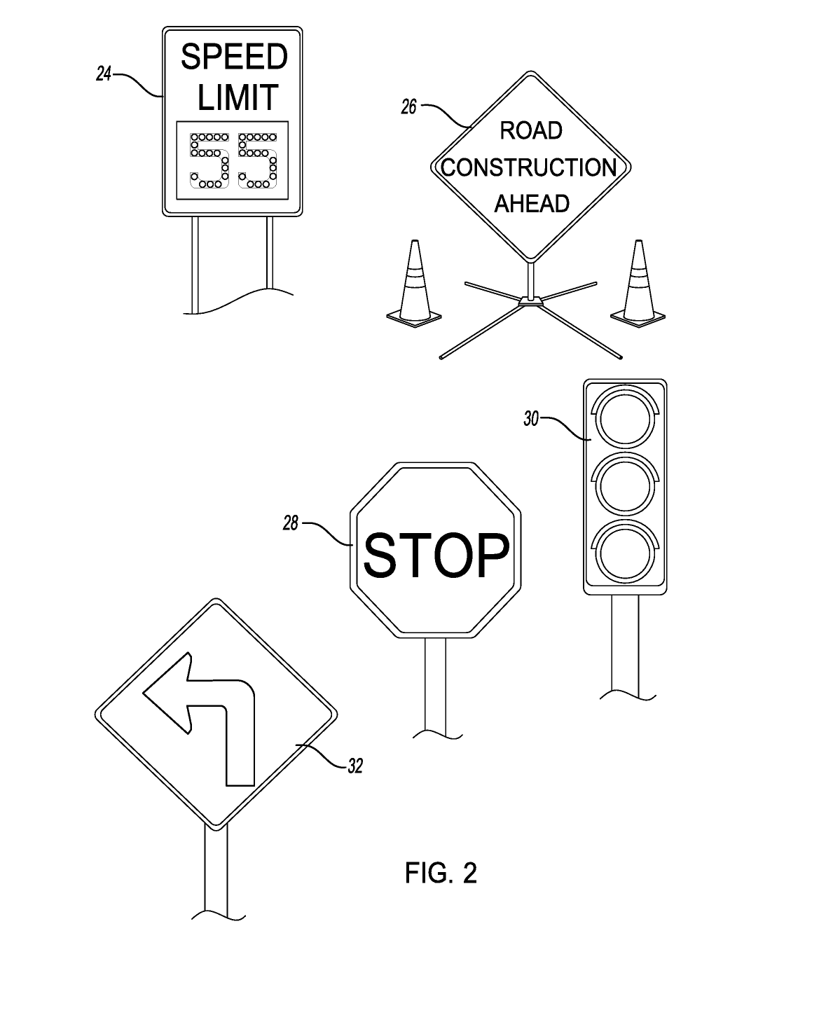

With reference now to FIG. 2, exemplary roadway signs which may be detected by the system 18 and shared among system vehicles are provided. The system 18 is configured to detect and classify roadway signage and provide the information with global coordinates to system vehicles over a wireless network such as a Dedicated Short Range Communication (“DSRC”) network. Accordingly, the system 18 is configured to share signage information such as, for example, speed signs 24, construction zones 26, stop signs 28, traffic light status 30 and directional road information 32, as well as unknown/new signs.

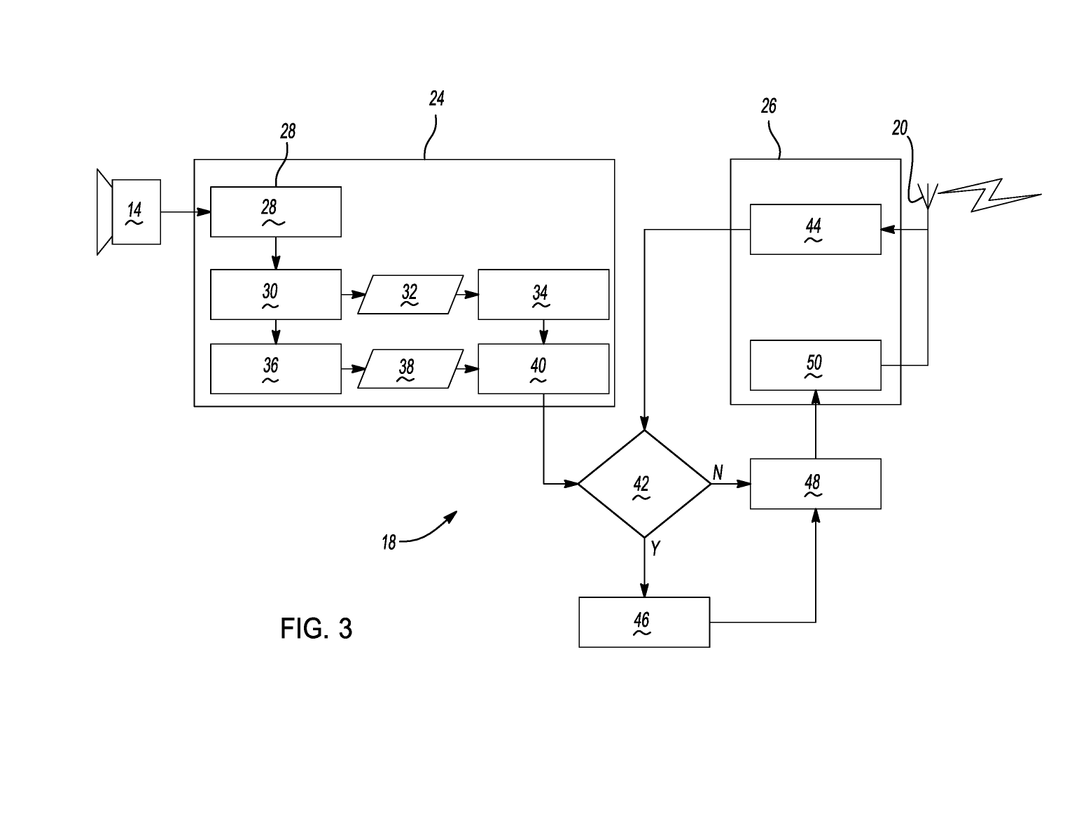

Referring to FIG. 3, the system 18, in addition to the camera 14, includes a controller with a detection and classification module 24 and a telematics communication module 26. Together, the detection and classification module 24 and the telematics communication module 26 includes a memory storing control logic and a processor to execute the control logic. Specifically, the detection and classification module 24 includes a submodule 28 that receives optical information, such as traffic light or sign information, from the sensor 14 and transmits the optical information to a traffic sign/light detection submodule 30. The detected information is transmitted to a traffic sign/light classification submodule 36 and a track list submodule 32. The classification submodule 36 classifies the particular type of signage scanned by the sensor 14, and the confidence level of specific data, such as a specific sign is determined in a class confidence submodule 38. The track list submodule 32 formats the information from the detection submodule 30 into a locally stored list. The data from the track list submodule 32 is transmitted to a range estimation module 34 that determines if the scanned data in the field of view 16 is applicable to the motor vehicle 10 for the present situation. The information from the range estimation module 34 and the class confidence module 38 are combined in a submodule 40.

The telematics communication module 26 includes a track data submodule 44 that receives V2X communication data through the antenna 20. This data is compared with the data from the combined data form the submodule 40 in a decision submodule 42. If the comparison is coincident, the compared data is transmitted to a fusion submodule 46 where coincidences and co-variances are generated and applied to the compared data to fuse the data. The fused data is then transmitted to a situational awareness track data generator submodule 48 that formats the compared data in an appropriate standard that is transmitted to a transmission submodule 50, which, in turn, transmits the fused data from the telematics communication module 26 through the antenna 20 to other vehicles or components in a V2X system as additional communication data. If the comparison is not coincident, the data from the detection and classification module 24 is not fused with the data from the track data submodule 44. As such, the communication data from the detection and classification module 24 is transmitted to track data generator submodule 48, which, in turn, transmits the fused data from the telematics communication module 26 through the antenna 20 to other vehicles or components in the V2X system as additional communication data.

In various arrangements, the sensor 14 can be a camera that receives traffic light status to verifying information accuracy of the traffic light. Further, the camera 18 is configured to measure the distance from road markings to, for example, the front tire. The measured distance between the road markings and the front tire may be used to calibrate the front camera while the vehicle is operating.

Hence, the system 18 includes an executable software program configured to recognize, classify and update traffic signals. Updating other V2X enabled vehicles, components, and the traffic controller about critical sign/light updates is beneficial for traffic management and other vehicle users. The method to detect signs/lights is using an optical device with algorithms capable of classifying these features in the scene and using a fusion engine to compare to what was previously there based on MAP data and output newly discovered signage over DSRC.

The system 18 is illustratively shown as using the camera 14 to sense traffic signs. The executable software program processes visual image detected by the camera 14 to determine if a traffic sign, or traffic light is detected. The traffic sign is classified and a global location of the traffic sign is determined. The traffic sign may be verified by classifications made by other system vehicles, and a confidence level is assigned to the traffic sign and shared among the system vehicles.

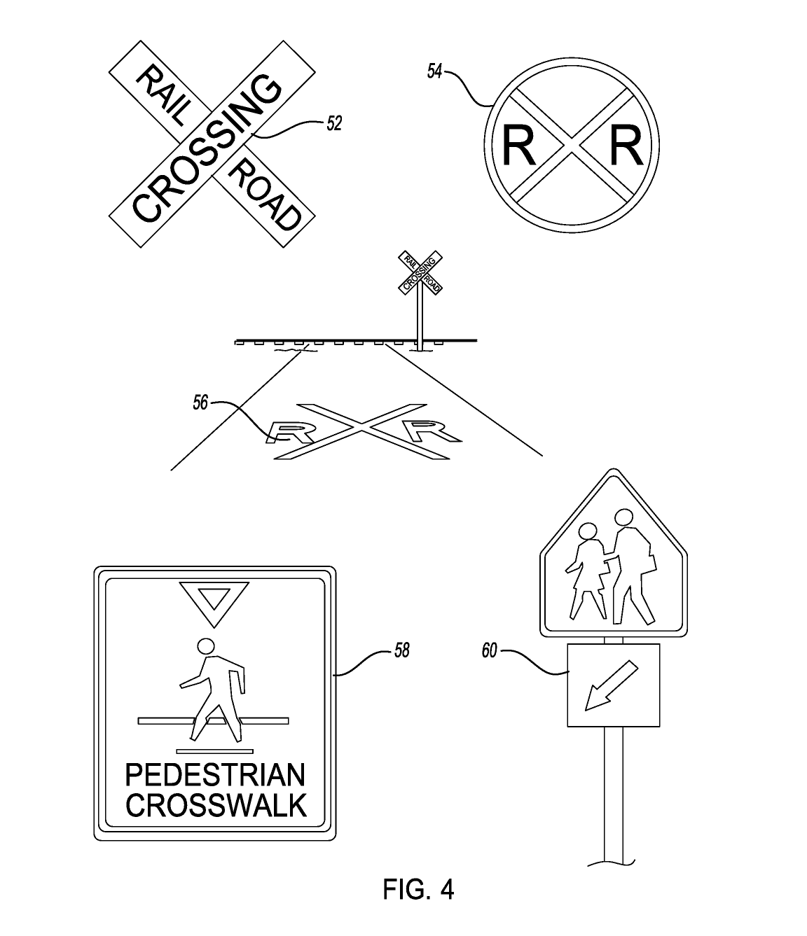

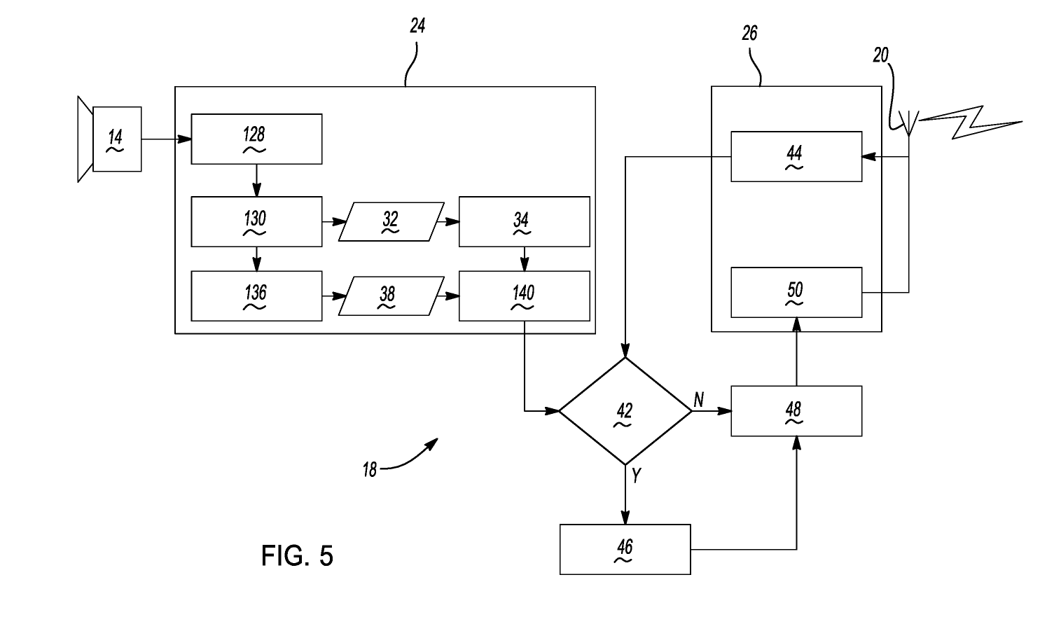

In another arrangement of gathering information for a V2X system, the system 18 utilizes sensors to detect and classify railroad track crossing or crosswalk information 52, 54, 56, 58, and 60 shown, for example, in FIG. 4. Referring to FIG. 5, the system 18 shares the information among the system vehicles and a traffic host. In this arrangement, the system 18 is similar to the arrangement shown in FIG. 3. To detect and classify road information shown in FIG. 4, the system 18 includes an image processing segment configured to process the signs, marks on the road and relevant information to identify railroad crossing and crosswalks. Specifically, the detection and classification module 24 includes a submodule 128 that receives crossing or crosswalk information from the sensor 14 and transmits the information to a crossing/crosswalk detection submodule 130. The detected information is transmitted to a crossing/crosswalk classification submodule 136 and the track list submodule 32. The classification submodule 136 classifies the particular type of crossing crosswalk scanned by the sensor 14, and the confidence level of specific data, such as a specific crossing/crosswalk is determined in the class confidence submodule 38. The track list submodule 32 formats the information from the detection submodule 130 into a locally stored list. The data from the track list submodule 32 is transmitted to the range estimation module 34 that determines if the scanned data is applicable to the motor vehicle 10 for the present situation. The information from the range estimation module 34 and the class confidence module 38 are combined in a crossing/crosswalk submodule 140. The remainder of operation of the system 18 is the same as described earlier with reference to FIG. 3.

Accordingly, the visual image from the camera 18 is processed by the image processing segment, that is, the detection and classification module 24 to identify railroad cross signs and crosswalk signs. The identified railroad cross signs and crosswalk signs are tracked, classified and shared among the system vehicles and traffic host through a wireless network. In other words the traffic signs are detected and identified using an optical device with algorithms capable of classifying these features in the scene and using a fusion engine to output this information over DSRC.

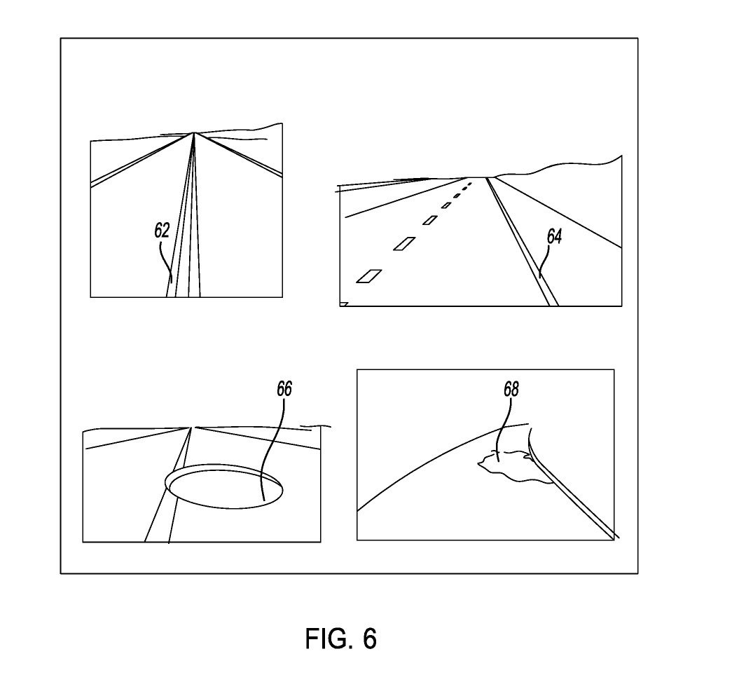

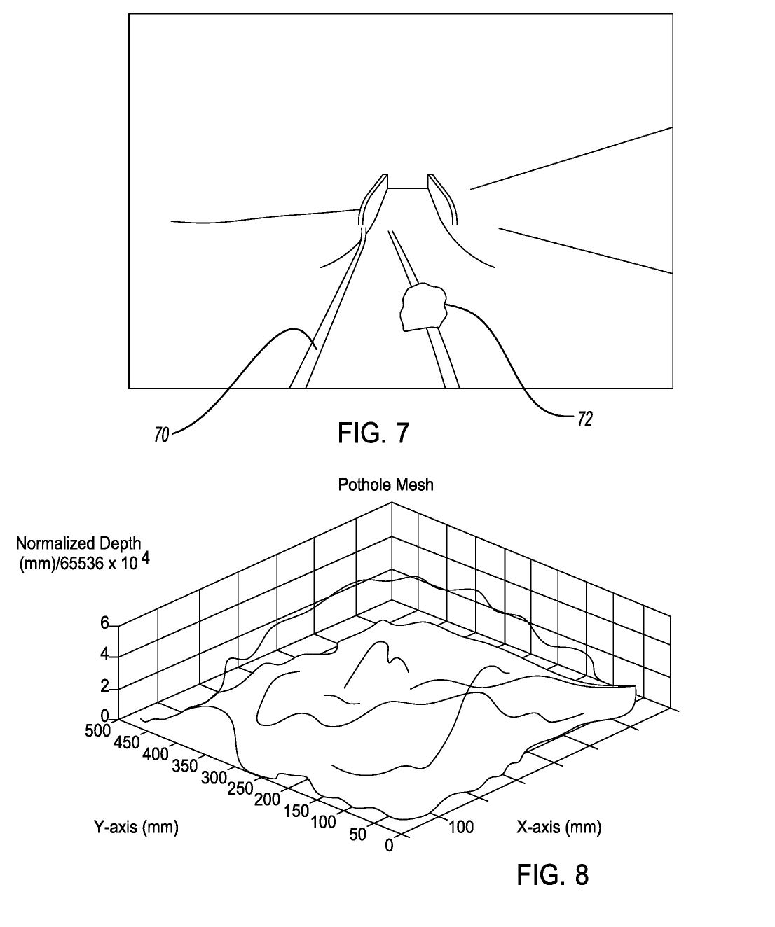

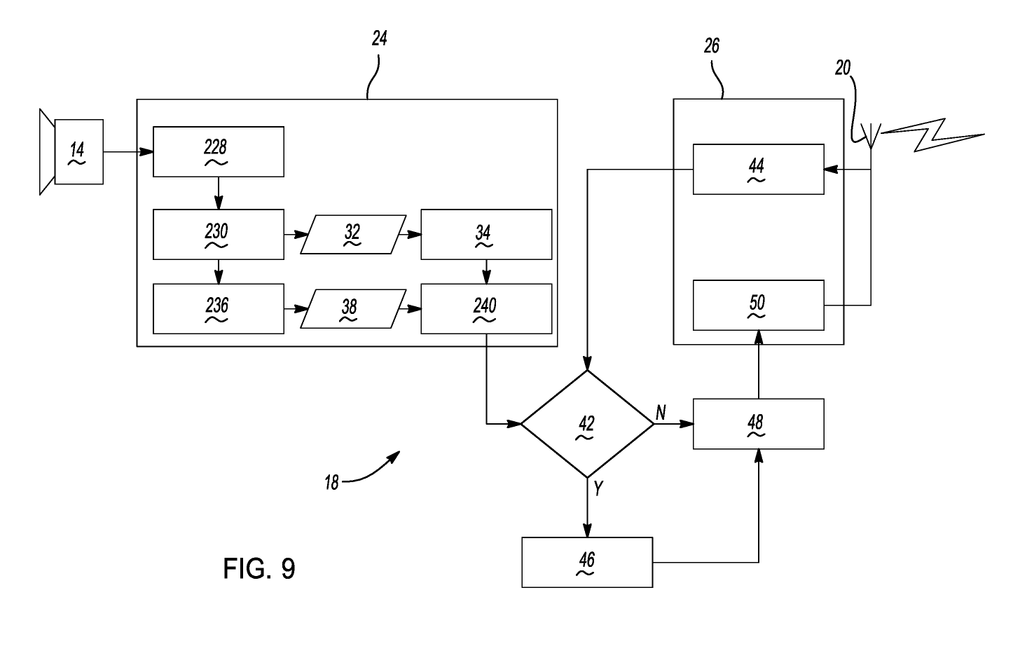

With reference now to FIG. 6, the system is configured to execute an algorithm to detect road information 62 and 64 and potholes 66 and 68 to update other V2X enabled vehicles and the traffic controller about critical road substrate types and condition for traffic management and other vehicle users. In this arrangement, the system 18 detects road substrate type and condition using the sensor 14 with algorithms capable of classifying these features in the scene and using a fusion engine to output this information over DSRC. Specifically, the detection and classification module 24 includes a submodule 228 that receives road condition information from the sensor 14 and transmits the information to a road condition detection submodule 130. The detected information is transmitted to a road condition classification submodule 136 and the track list submodule 32. The road condition classification submodule 136 classifies the particular type of road condition scanned by the sensor 14, and the confidence level of specific data, such as a specific road condition is determined in the class confidence submodule 38. The track list submodule 32 formats the information from the detection submodule 130 into a locally stored list. The data from the track list submodule 32 is transmitted to the range estimation module 34 that determines if the scanned data is applicable to the motor vehicle 10 for the present situation. The information from the range estimation module 34 and the class confidence module 38 are combined in a road condition submodule 140. The remainder of operation of the system 18 is the same as described earlier with reference to FIGS. 3 and 5. An illustrative example of a system 18 processing information from a road 70 with a pothole 72 is shown in FIG. 7. The characteristics of the pothole 72 determined by the system 18 is shown as a 3D graph in FIG. 8, which is shared with other vehicles in the V2X system.

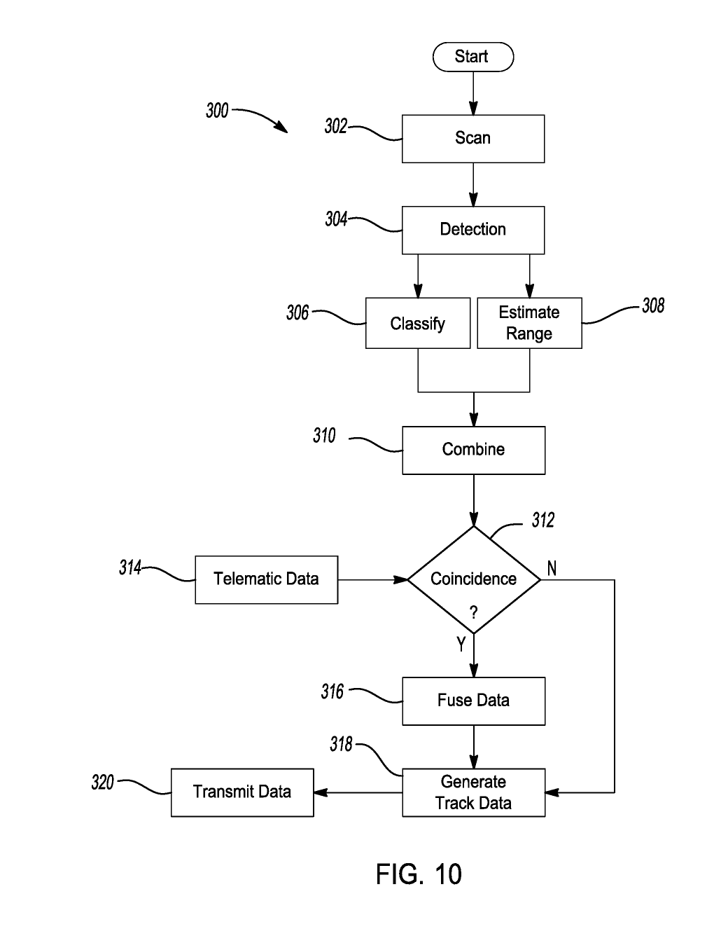

Turning now to FIG. 10, the overall operation of the system 18 is summarized in a process 300. At step 302, the system 18 performs an optical scan with the sensor 14. This information is detected at step 304. The detected optical information is classified at step 306, and the range, for example, the distance from the vehicle is estimated at step 308 to determine if the optical information is applicable to the vehicle. At step 310, the information from steps 306 and 308 are combined. The combined data from step 310 is then compared from telematics communication data from step 314 at a decision step 312. If the data from steps 310 and 314 are coincident, the data is fused together at step 316. The fuse data 316 is them formatted into an appropriate standard at step 318 and transmitted as new communication data from the vehicle at step 320 to other vehicles in a V2X system. If the compared data is not coincident, the data from step 310 is forwarded to the step 318 where the data is formatted to the appropriate standard before being transmitted from the vehicle at step 320 as new communication data.

The description of the invention is merely exemplary in nature and variations that do not depart from the gist of the invention are intended to be within the scope of the invention. Such variations are not to be regarded as a departure from the spirit and scope of the invention.

What is claimed is:

1. A system for detecting and classifying information for a motor vehicle, the system comprising:
a sensor mounted within the motor vehicle; and
a controller in communication with the sensor and having a memory for storing control logic and a processor configured to execute the control logic, the control logic capturing optical information from the sensor, classifying the optical information, comparing the classified optical information with communication data received by the motor vehicle, generating fused information based on the comparison, and transmitting the fused information from the motor vehicle as a source of additional communication data.

2. The system of claim 1 wherein the sensor is a forward-view camera.

3. The system of claim 1 wherein the optical information includes road signage.

4. The system of claim 1 wherein the optical information includes road surface conditions.

5. The system of claim 1 wherein the controller includes a detection and classification module that captures the optical information from the sensor and classifies the optical information.

6. The system of claim 5 wherein the detection and classification module stores the optical information in a track list.

7. The system of claim 6 wherein the detection and classification module includes a range estimation module that determines if the track list information is relevant to the motor vehicle.

8. The system of claim 1 wherein the controller includes a telematics communication module that receives communication data and transmits the additional communication data.

9. The system of claim 8 wherein the controller includes a target fusion module that receives the classified optical information and the communication data and generates the fused information.

10. The system of claim 9 wherein the target fusion module generates the fused information when the classified optical information and the communication data are coincident.

11. A method for detecting and classifying information for a motor vehicle, the method comprising:
capturing optical information with a sensor;
classifying the optical information;
comparing the classified information with communication data received by the motor vehicle;
generating fused information based on the comparison of the classified information and the communication data; and
transmitting the fused information from the motor vehicle as a source of additional communication data.

12. The method of claim 11 wherein the sensor is a forward-view camera mounted within the motor vehicle.

13. The method of claim 11 wherein capturing optical information includes capturing information of road signage.

14. The method of claim 11 wherein capturing optical information includes capturing information of road surface conditions.

15. The method of claim 11 further comprising storing the optical information in a track list.

16. The method of claim 15 further comprising estimating if the track list is relevant to the motor vehicle.

17. The method of claim of claim 11 wherein a telematics communication module receives communication data and transmits the additional communication data.

18. The method of claim 17 wherein a target fusion module receives the classified optical information and the communication data and generates the fused information.

19. The method of claim 18 wherein the target fusion module generates the fused information when the classified optical information and the communication data are coincident.

20. A system for detecting and classifying information for a motor vehicle, the system comprising:
a detection and classification module that captures optical information from a forward-view camera and classifies the optical information as classified data; and
a telematics communication module that receives communication data; and a fusion module that combines the classified data and the communication data into fused information, the telematics communication module transmitting the fused information from the motor vehicle as a source of additional communication data.
